(19) United States
(12) Patent Application Publication
(10) Pub. No.: US 2024/0107959 A1
(43) Pub. Date: Apr. 4, 2024

(54) ADAPTIVE PID CONTROLLER FOR A HYDROPONICS OR AQUAPONICS SYSTEM

(71) Applicant: KB Cultivators LLC, Tysons, VA (US)

(72) Inventor: Alexander Bacon, Middletown, VA (US)

(73) Assignee: KB Cultivators LLC, Tysons, VA (US)

(21) Appl. No.: 18/375,830

(22) Filed: Oct. 2, 2023

Related U.S. Application Data
(60) Provisional application No. 63/378,100, filed on Oct. 3, 2022.

(51) Int. Cl. A01G 31/02

(52) U.S. Cl. CPC A01G 31/02

(57) ABSTRACT

A hydroculture control system includes a controller, a plurality of lights controlled by the controller, a flood tray illuminated by the plurality of lights, a water reservoir, and a plurality of sensors configured to take measurements and send data to the controller. Water is circulated between the flood tray and the reservoir via a pump. Plants are grown in a substrate in the flood tray. The controller, which may be an adaptive PID controller, is configured to trigger one or more systems, such as exhaust fan, de-humidifier, air pump, chiller, to modify environmental conditions of the flood tray in order to maintain optimal levels for enhanced plant growth. The system may be fully automated and designed to operate in an environment under certain conditions wherein there is no network connectivity.

### TECHNICAL FIELD

The present disclosure relates to the field of hydroponics, aquaponics or in general hydroculture and control systems thereto.

### BACKGROUND

Hydroculture techniques like hydroponics or aquaponics involve growing fruits, vegetables or flowers in a soilless media by using water-based nutrient solutions in hydroponics and nutrient-rich aquaculture water being fed in aquaponics for plant growth.

Such a hydroculture technique typically consists of a flood tray where the plants are grown on a substrate, where the water is circulated from a reservoir and is illuminated by a dimmable light. An array of sensors measures all the aspects which affect plant growth, in both water and air, and informs a controller which in turn triggers systems which maintain all aspects of water and environment at optimal levels for enhanced plant growth.

The proportional-integral-derivative controller (PID, or PID controller) is the most common controller and stabilizer technique used in industry for controlling these systems. In most of the real applications, the controlled system has parameters which slowly vary or are uncertain. Thus, PID gains must be adapted to cope with such changes. A challenging problem in designing a PID controller is to find its appropriate gain values (e.g., proportional gain, integral gain, and derivative gain). Moreover, in case where some of the system parameters or operating conditions are uncertain, unknown, or varying during operation, a conventional controller would not change its gains to cope with the system changes. Therefore, a tuning method is needed.

An adaptive PID will tune the PID gains to force the system to follow a desired performance even with the existence of non-static environmental factors.

### SUMMARY

The present disclosure relates to a control technique to manage various input/outputs or sensors and actuators for growing plants in a controlled growth environment while storing and logging all sensor data to update automated grow programs for optimization and efficiency in cultivation.

These and other objects and advantages of design and method described in the present disclosure will be apparent from the further detailed description and drawings included in this application.

### BRIEF DESCRIPTION OF DRAWINGS

The following drawings illustrate various examples of various components and logic of the inventions disclosed herein and are used for illustrative purposes only. Embodiments of the disclosure are illustrated by ways of example and not limitation in the figures of the accompanying drawings.

FIG. 1 depicts an exemplary hardware configuration of an exemplary embodiment according to this disclosure.

FIG. 2 depicts an exemplary pH cycle according to an embodiment of this disclosure.

FIG. 3 depicts an exemplary active photosynthetic cycle according to an embodiment of this disclosure.

FIG. 4 depicts an exemplary nutrition cycle according to an embodiment of this disclosure.

FIG. 5 depicts an exemplary hardware configuration of an exemplary embodiment according to this disclosure.

FIG. 6 depicts an exemplary adaptive PID loop according to an embodiment of this disclosure.

FIG. 7 depicts an exemplary grow plan according to an embodiment of this disclosure.

### DETAILED DESCRIPTION

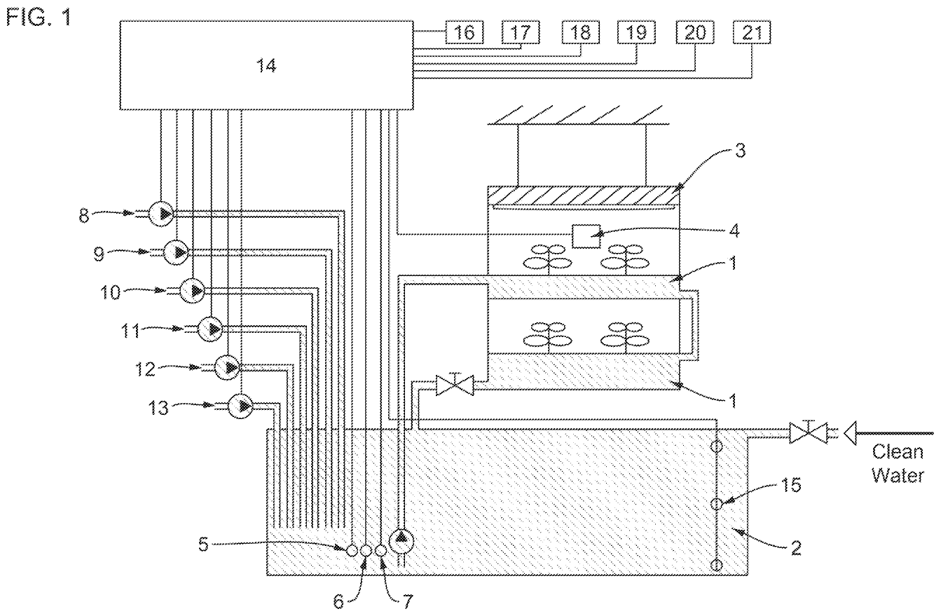

The hydroculture technique typically consists of variety of components. FIG. 1 depicts an exemplary system. While FIG. 1 includes various components, it is understood the different components, more, fewer, or other orientations of components can be implemented depending on the system requirements.

All identically numbered reference characters correspond to each other so that a duplicative description of each reference character in the drawings may be omitted.

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

As shown in FIG. 1, the system includes one or more flood tray(s) 1 where plants are grown in a substrate and water is circulated to, e.g., at regular intervals. The flood tray 1 may be illuminated by a plurality of lights 3 (e.g., LED lights) which is dimmable and controlled for varying ambient temperature and Photosynthetically Active Radiation (PAR) sensors, Photosynthetic Photon Flux Density (PPM), and other relevant parameters.

Carbon Di-Oxide (CO2), temperature, and humidity may be measured in real time (or at intervals) using environmental sensor(s) 4 which will may also derive parameters like VPD (Vapor-pressure deficit), Dew Points, etc to help optimize plant growth.

The water is circulated from reservoir 2 to regulate the acidity or nutrient values of the water in the flood tray 1 via the use of various additives as discussed below.

The water level in the reservoir 2 is measured, for example, with water level sensor 15. The electrical conductivity (EC) level of the reservoir 2, for example, is measured by conductivity sensor 5. The pH level of the reservoir 2, for example, is measured by a pH sensor 6. The nitrogen, phosphorus, and potassium (NPK) level of this reservoir 2, for example, is measured by NPK sensor 7. The aforementioned sensors 5, 6, 7 can be configured to take measurements and send data to controller 14 in real time or predetermined intervals (e.g., every hour, 12 hours, or 24 hours).

In hydroponics, for example, acid solution 8, base solution 9, nutrients (NPK) 10, veg 11, flower 12 and rooting hormones 13 may be dispensed into the reservoir 2 using, for example, peristaltic pumps from separate storage or smaller refillable reservoirs (not shown in FIG. 1).

In aquaponics, for example, the reservoir 2 may be used for aquaculture (raising aquatic animals such as fish, crayfish, snails, or prawns in tanks) whereby the nutrient-rich aquaculture water is circulated through the flood tray 1.

Water may be circulated continuously or at regular intervals between flood tray 1 to reservoir 2 using pump 22.

A clean water source (not shown in drawings) may also be available to replenish water levels in the reservoir 2.

With all the data from the sensors coming in, the controller is configured to trigger one or more of the following to achieve optimal plant growth: exhaust fan[s] 16, de-humidifier[s] 17, air pump[s] 18, chiller[s] 19, CO2 20 and other user preferred method[s] 21.

In embodiments of the present disclosure, an adaptive PID controller 14 may manage all the cycles and processes based on real time inputs from the sensors, e.g., including to calculate and control the pumps and actuators or outputs to achieve optimal plant growth.

An adaptive PID loop designed and tuned to optimize the complete grow environment (e.g., temperature, humidity, VPD, all Hydro Conditions, NPK ratios) may be based on sensor feedback by engaging auxiliary systems which can alter the grow environment.

The PID loop is used to deal with the immediate environmental changes and engage the connected ancillary systems to further condition the environment to a finite degree. The PID loop is configured to make deterministic decisions on the actions to take to maintain a perfect complete environment based at least in part on the system history.

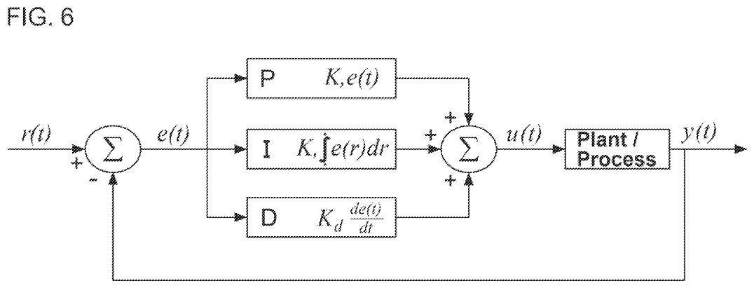

The following discusses the details the basis of an adaptive PID loop that may be enacted by the system and as shown in FIG. 6.

“P”—Term P is proportional to the current value of the SP (Setpoint)—PV (Measured Process Variable) error. For example, if the error is large and positive, the control output wilt be proportionately large and positive, considering the gain factor “K”. Using proportional control alone will generally result in an error between the setpoint and the actual process value because it requires an error to generate the proportional response. The controller cannot adjust the system unless there is an error present.

A “Proportional” loop works based on the concept of creating an error value that grows larger as the PV drifts further away from the SP. So, if the system is optimized to be 70 degrees in the environment, that would be the SP. The PV would be the current temperature in the environment (e.g. from a temperature sensor), that should be adjusted to the SP. Meaning, if it is 74 degrees in a room, the PV is 74 and the SP is 70 degrees.

The Proportional Loop is an On/Off switch, therefore the probability of it being engaged on and off often is high due to environmental factors not remaining static. Meaning, that if the temperature setpoint for the tent is 70, and it drifts to 70.1, a proportional loop would start. When it reaches the 70 degrees, the proportional loop would stop. The system can mitigate the frequent on/off scenario is by adding an “Integration” loop such as by using the 1 band, explained below.

“I”—Term I accounts for past values of the SP—PV error and integrates them over time to produce the I term. For example, if there is a residual. SP—PV error after the application of proportional control, the integral term seeks to eliminate the residual error by adding a control effect due to the historic cumulative value of the error. When the error is eliminated, the integral term will cease to grow. This will result in the proportional effect diminishing as the error decreases, but this is compensated for by the growing integral effect.

The integration loop considers both current and past error margins between SP and PV, and waits before enacting a change. Thus, based on adding the integration loop, the above scenario changes as follows: if the environmental setpoint is 70, and drifts to 70.1, the controller allows the error value (the difference between the SP and PV) to integrate and is ready to enact a change, but due to the integration time, waits until the error value is present for a certain percentage of the time before enacting the proportional loop. Otherwise stated, the controller does not immediately turn on to remove the 0.1 of a degree that is off from the SP. As the controller has seen in the past that the temperature fluctuates like that often, only when the error value continues to grow in a linear fashion for a certain percentage of time will it enact the proportional loop and begin removing the excess heat.

The loop's ability to consider future possibilities and make deterministic changes based on that is due to its derivative loop, explained below.

“D”—Term D is a best estimate of the future trend of the SP—PV error, based on its current rate of change. It is sometimes called “anticipatory control”, as it is effectively seeking to reduce the effect of the SP—PV error by exerting a control influence generated by the rate of error change. The more rapid the change, the greater the controlling or damping effect.

The derivative loop allows the system to consider how often the error values are coming in, and make changes to the P and I loop to smooth (lessen) the error value frequency. What this means is that the more often an error occurs, the more control the system exerts to enact the appropriate change in the most efficient way possible.

In embodiments of the present disclosure, the controller trends and logs all information internally and may send updates (either in real time or hatched such as at the end of the day) with the information. This updates the original file that was created showing the possible run conditions from the beginning, and will continue to update with more information each day.

The controller will send the information to the server to update the individual grow according to a predetermined schedule such as once a day. The controller, or related application/website, can display the data, but the trended data file (grow log) will be updated, e.g., once a day after the controller sends the batch information for the day to the server at midnight.

The information from the PID loop and from the ultimate harvest may then be used to update the growth models in the system. More specifically, from the grow plans and the PID information, the information can continually be updated upon completion of each grow so that the controllers are updating the efficiency of the grow plans on the database. Meaning, with each growth, the controller should update the database/update with the aggregated data, which further improves the grow model. When the grow is completed (e.g., the plant is harvested), the user can enter in yield information and store their file wherever they want. That information, including harvest total, will update to the system because the grow information has been hatching updates to the database (e.g. data stored on server) every night (or in real time or other intervals). Upon completion, the database can then look at the file, and actively update the grow plan in accordance with the newly received data, based on the total grows data.

The server may be configured to only update the files as completed grow plans are received, though it may also update more or less frequently as new data becomes available. The server will, be configured to update the grow programs information based on the sensor data received from the other completed alike grow programs, e.g., same plant name and species, such as tomato, heirloom. The system can be designed to determine and share a recommended grow plan. For example, if User A grows 12 tomatoes, and User B grows ten tomatoes, and the only determined difference was that User A had a different NPK ratio than User B, then the controller may update the Grow Plan for tomatoes with User A's nutrients NPK Ratio as the preferred NPK ratio because it results in a 20% higher yield only by changing the NPK ratio of the reservoir 2 during the specific growth cycles, e.g., used a different manufacturers nutrients.

One present system is configured to build a genetic blueprint for each hydroponically grown plant, which enables the controller to track and trend data to enhance the efficiency and viability of the Growth Plan. For example, the sensor information received allows the system to compare the yields and viability of grows performed with the system, comparing different nutrients, conditions, etc. Based on this information and the yield information entered by users, the system is configured to develop recommended Grow Plans, which may vary over time based on the input.

As discussed below, the present system and method is configured to control grow conditions (e.g., the environmental factors) in a specific location and optimize the growth of specific plants.

Regarding the grow conditions, the grow conditions may be different depending on the specific hardware used, the geographic location of the system, and even the location of the system within (or without) a certain building.

Accordingly, at the outset of implementing a system disclosed herein, the system may first run a Learning Mode to establish a system baseline. In this mode, for example, the user will set up the growing environment (e.g., grow tent,) with all accessories, including to hang and connect the light, fill the reservoir 2 with water, connect the fans, and everything else necessary to start a new grow, but excluding the plants. This may also include inputting equipment data into the system such as light wattage, NPK ratio of nutrients, serial numbers, manufacture name, etc.

Once initiated, the controller 14 will begin to increase the light, e.g., starting at 10%, and will seek to maintain a certain temperature (e.g. 70 degrees Fahrenheit), with a certain humidity (e.g., 55% humidity), a certain water temperature (e.g., 70 Fahrenheit), and a certain pH level (e.g., 5.9) in the reservoir 2 without adding any growth specific nutrients. For example, the controller will adjust the light to 10% and the light will stay at this wattage (65 watts) for 2.4 hours. The Temperature and humidity setpoint the controller 14 will try to maintain at each stage is 70 degrees Fahrenheit with 55% humidity.

If the light being at 10% raises the temp of the tent above 70 degrees Fahrenheit, the controller will begin to ramp up the fans to maintain the 70 degree setpoint. If the humidity of the environment goes above 50%, it may engage a dehumidifier. If the water temperature goes above 70 degrees Fahrenheit, the controller will engage a chiller relay to maintain the water temperature.

When the environment reaches both temperature and humidity setpoints, the controller 14 will note the sequence it used (e.g., the ramping of the fans, how long it took to reach the setpoints under the given conditions, whether it had to use both fans, when it turned the dehumidifier, etc.) and log that to be used as historical data the controller 14 can use later to then efficiently adjust the associated fans to achieve setpoint.

For example, the first time the controller 14 was at 60 watts and the temperature went above 70 degrees, the controller 14 cycled fan 1 from 0% to 60% overshooting the setpoint slightly, but was able to maintain at 70 degrees while the fan was at 40%. In subsequent iterations the controller 14 will ramp fan 1 to 40% and maintain at 40% to meet setpoint under the same/similar conditions without the overshoot.

The controller 14 will do this uniformly, raising the light 10% every 2.4 hours, until it can no longer achieve 70 Fahrenheit and 50% humidity. When it can no longer achieve the setpoint, the controller 14 will note the conditions it can meet setpoint under (e.g., what is the highest wattage the controller can ramp the light up to and still maintain temp and humidity), and use that data to form its operating parameters. These operating parameters represent the possible bounds of the environment.

For example, the controller 14 after the 24-hour Learning Mode determined that above 500 of the 680 available watts on the light, it was no longer able to maintain 70 degrees Fahrenheit with 50% humidity. It will then note that the wattage max is 500 for the environment, and that going above will not allow the controller 14 to maintain the 70-degree setpoint. If the controller goes through the entire Learning Mode and ramps the lights 3 to 100% and maintains temp the entire time, then the wattage max would be 680, in this example. The controller 14 should note all the way up to 100% what temperatures and humidity it can maintain in the specific environment

For example, if the controller 14 can maintain 73 degrees at 100% of the light wattage, it should track, trend, and display such information. That way the system knows what temps and conditions can be maintained overall for the tent and given light.

The controller 14 will balance the reservoir 2 at the beginning of the cycle to a pH of 5.8, and maintain the reservoir 2 pH level the entire time. During this tine, also, the controller 14 may also engage the chiller to maintain 70-degree water.

At the end of this 24-hour period, the controller will generate a report showing what setpoints it can maintain given the current environment. For example, “Given the static environment, your controller estimates it can maintain an environment of up to 70 degrees Fahrenheit, with 50% humidity, with water levels maintaining at 70 degrees Fahrenheit, with 5.8 pH and a 4:3:7 NPK ratio up to 600 watts. Running the lights 3 above 600 watts are not recommended and will result in setpoints not being met.”

The controller 14 may then form the report from the information. it receives from the sensors during the 24-hour test period. Meaning, if it cycles the 650 watts light up to 625 watts, and cannot maintain the setpoints, it will stop there, and return to the last lighting percentage it could maintain the setpoint at. The controller 14 will re-confirm it can maintain at that previous highest wattage, and make note of the percentage it stopped being able to maintain the temperature at before continuing to the end of the cycle.

The controller 14 may also connect to a network (e.g., the Internet via Wi-Fi) for server automation control.

Accordingly, the system can fully automate the grow experience, e.g.,. lights 3, hydro, nutrients, air temp, etc. For each grow, a grow program based on a growth model (discussed below) will be provided as to what setpoints are to be maintained from start to finish. These are the basics of the “Grow Plans” or “Grow Programs”. This grow program is uploaded to the controller from the server at the beginning of the grow. That way, if the system loses the network connection, the controller will still be able to run the program from start to finish.

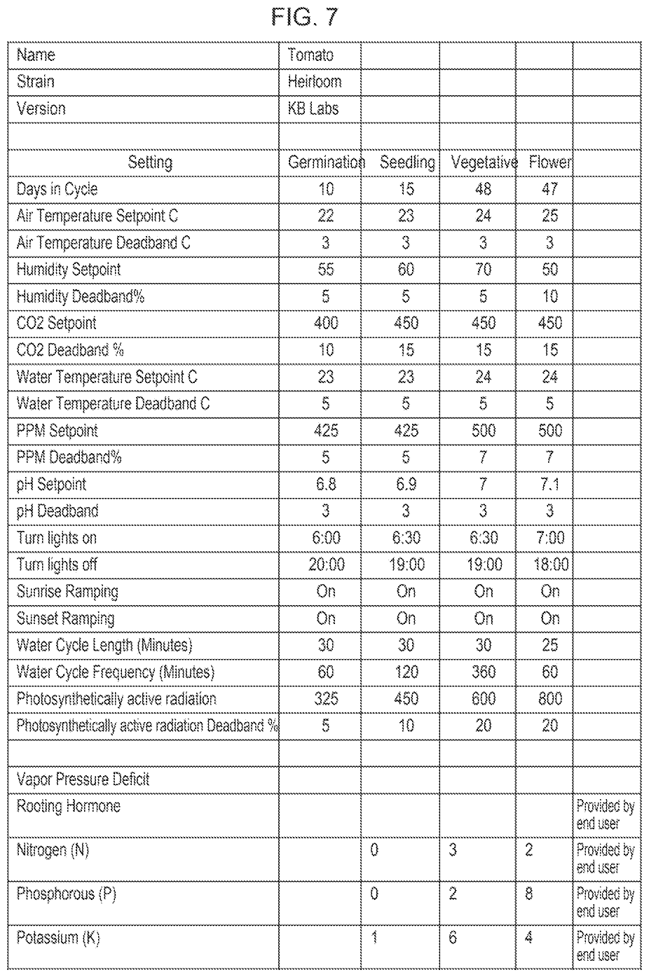

Regarding optimizing the growth of the plants in the system, the system (e.g., controller) will rim a grow plan which is optimized for the growth of a specific plant. For example, certain strains of tomatoes may grow better in different conditions (e.g. higher humidity or lower heat). FIG. 7 illustrates one example grow plan according to one embodiment of this disclosure.

The grow model may comprise a Grow File that will show the temperature over the course of the entire grow, e.g., same with other sensor data. The Grow File will be continually updated by the server so the system can reference, for example, the previous weeks' data. That way, at the end of each week, the system will be able to look at the information, and determine if there are any issues, or if there are problems maintaining the setpoints sent to it from the server, (e.g., the user receives their weekly email and sees that the average humidity drops 10% during the night. The user can then use this information to decide whether to adjust the humidifier deadband to compensate for the difference.)

For example, at the end of each week, the server may be configured to send a “Weekly Data” email, that contains the updated file with all the above-mentioned information so the user can see if they are maintaining appropriate environment temp, humidity, pH, NPK ratio, PPM and water temp, average lighting par, lighting watts. The weekly email will contain a Grow File that shows everything in an easily readable format, showing the averages and last current reading on all sensors. The user should have access to the Grow File at any time (e.g., from both their app and the website), which enables the user to look at all old and current grows happening at any time.

The system may implement an adaptive PID loop controller (described above) to enact the grow model as discussed above, e.g., to respond to immediate environmental changes and engage the connected ancillary systems to further condition the environment to a finite degree by looking at history to make decisions on actions to take to maintain a desired environment.

For example, in a system with an exemplary adaptive PID loop controller based on a grow model with a temperature setpoint of 70 degrees with the light set to 600 watts, if the temperature is above the setpoint of 70 degrees, the controller 14 ramps the two fans, starting with a Fan 1 and moving to a Fan 2, until the temperature setpoint of 70 degrees is met.

In that example, the first. time the controller 14 encountered these conditions, it ramped the fans to 100% over a period of 1 minute, causing the temperature to overshoot to 68 degrees. Consequently, it then had to make further adjustments to bring the environment back to 70 degrees by slowing the fans to 0, re-adjusting back to 20, and repeating in kind until the temperature condition was satisfied.

The second time the controller 14 encounters the same conditions, it utilizes that data including the history of previous work performed. to adjust to the change. For example, the controller determines that if it slows the ramping time, it can maintain the 70-degree setpoint: by increasing one fan to 40% and maintaining for 1 minute, achieving the desired temperature setpoint without overshooting and having to make further adjustments.

Thus, the controller can further its data on adjusting the error value and allowing it to adapt quicker in the future. As the setpoint of 70 degrees is met, it must then be maintained for the fan to slow down and eventually turn off. The controller sees that as soon as the fan goes below 40% run speed, the temperature begins to slowly climb hack up. The controller adjusts back to 40% and maintains temperature. The controller makes the decision to maintain fan 1 at 40% the entire time to maintain the setpoint of 70 degrees.

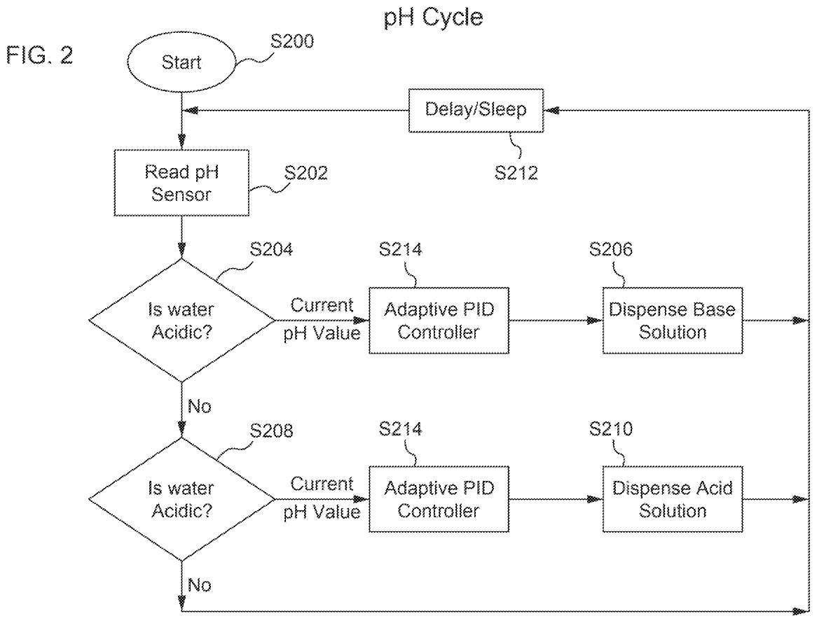

FIG. 2 is an exemplary flowchart illustrating an embodiment where pH values of the water are maintained for optimal plant growth according to an adaptive ND controller 14. As shown in FIG. 2, after starting the process S200, the system receives data from the pH Sensor S202 and determines, based on the received data, whether the water is acidic S204.

The acidity determination may be based on a predetermined threshold value, which may also be adjusted based on other circumstances such as the plants being grown and/or the stage of plant growth.

If the acidity is not within the predetermined threshold, the adaptive PID controller 14 will enact systems to adjust the pH, such as adding a base solution S206, according the adaptive PID controller 14 discussed above.

If the system determines that the water is not acidic, then the system retests the acidity. If the water is again below the acidity threshold, the system enters a delay/sleep mode S212 before restarting the process.

According to one embodiment, the adaptive PI D controller 14 is programmed to re-verify the test on the water. This process is specific to the water pump engaging before a feeding cycle. Every time before the water pump turns on, the controller verifies the pH, NPK & ppm of the water. If the controller determines that NPK needs adjustment, then it may also determine that the pH needs adjustment, because nutrients can affect pH levels.

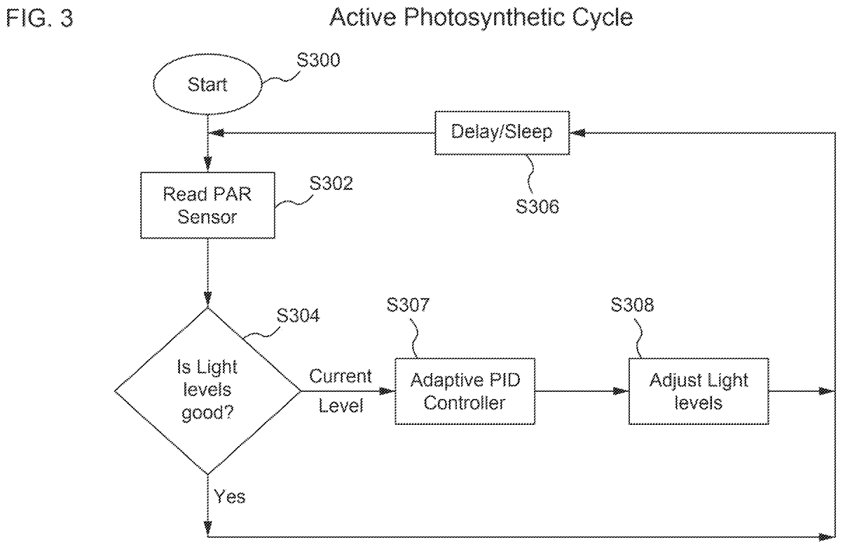

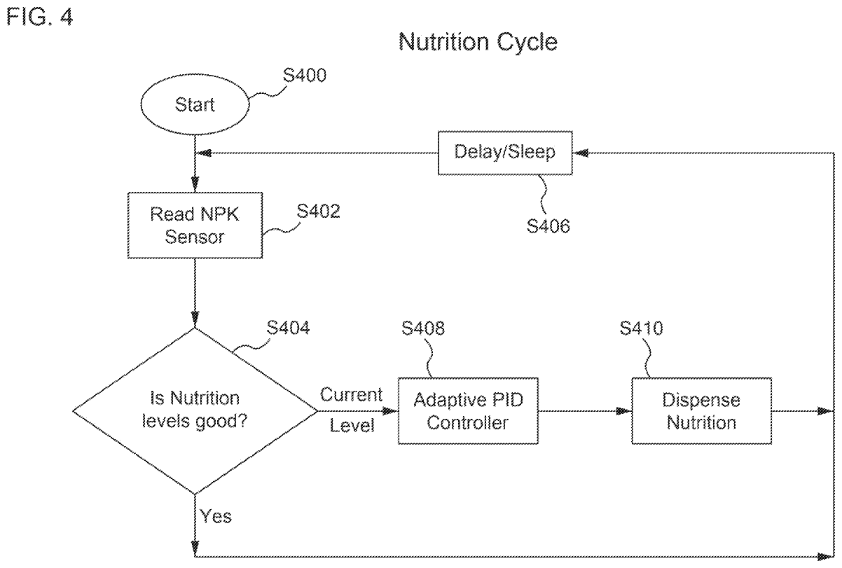

FIGS. 3 and 4 illustrate examples of the active photosynthetic cycle and the nutrition cycles being managed by the adaptive PID controller 14. Similarly, all the cycles such as, but not limited to, growth temperatures, ambient humidity, CO2, etc. during the plant growth may be maintained by the adaptive PID controller.

As shown in FIG. 3, for example, after starting the process S300, the system reads the PAR (Photosynthetically Active Radiation) Sensor S302. If the light level is acceptable S304, then the system enters a delay/sleep mode S306 before restarting the process.

If the light reading is not acceptable (e.g., too high or too low), then the system sends the current light level to the adaptive PID controller S307. If the light reading is not within the threshold, the adaptive PID controller 14 will enact systems to adjust the light S308, such as changing the light power, according the adaptive PID controller 14 discussed above.

In FIG. 4, after starting the process S400, the system reads the NPK Sensor S402. If the nutrition level is acceptable S404, then the system enters a delay/sleep mode S406 before restarting the process.

If the nutrition reading is not acceptable (e.g., too low), then the system sends the current nutrition level to the adaptive PID controller S408. The adaptive PID controller is configured to enact systems to adjust the nutrition, such as adding a nutrition solution, according the adaptive PID controller discussed above S410.

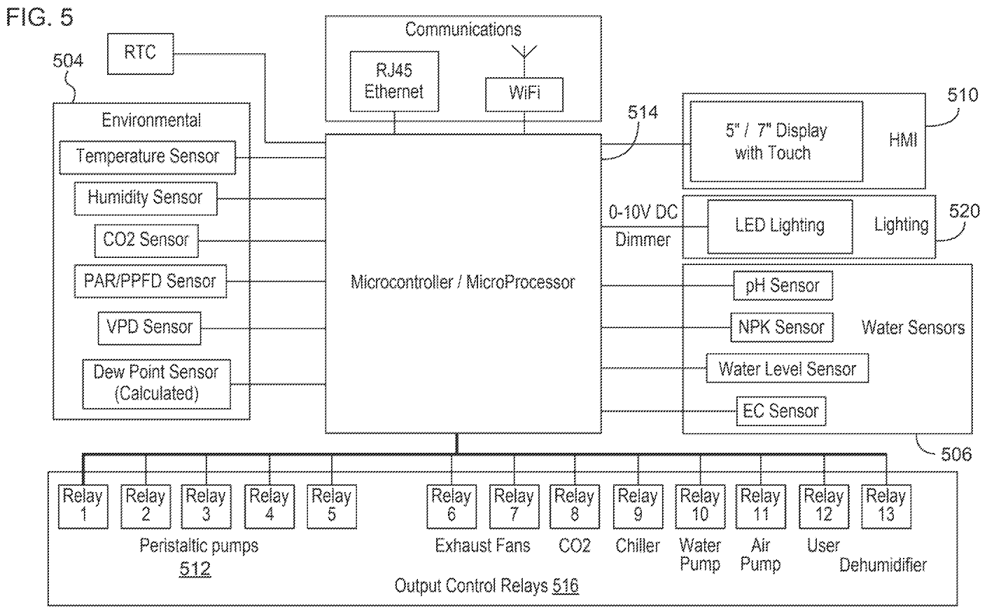

FIG. 5 depicts an exemplary hardware configuration of an exemplary embodiment according to this disclosure.

The embodiment of the system depicted in FIG. 5 includes the components and sensors described below and may correspond to the similarly named components described in FIG. 1. As understood, the various components and sensors may be combined or separated into multiple components and other or fewer sensors based on the system requirements.

According to one embodiment, for example the system includes a wall-mounted unit with a separate 7-inch human machine interface (HMI) or touchscreen 510 that may be powered by a 120-240 VAC DC power supply. The HMI 510 will be used to manipulate, deploy, and monitor the environmental conditions. The system includes five dosing pumps 512 (e.g., peristaltic dosing pumps) that are in a separate housing and are encased as a pump unit. The dosing pumps are connected to controller 514 (e.g., via plug-in with a single plug). The controller has 8 female plugs built into the controller that are used to manipulate different systems 516 (e.g., relays 6-13) to control the environment and hydro aspects of the grow. As described below, the unit includes an environmental sensor 504 and one or more water sensors 506 that communicate with the controller 514 (e.g., plugs in to the controller).

The controller 514 may be attached to the HMI via a long and flexible cable that will allow the user to hang the HMI 510 on the front of the tent, not on the inside, for best accessibility. The controller 514 itself may be housed on the inside of the tent.

It is understood that While the controller 514 may be a hardware controller positioned at the grow location, the controller 514 may also be a networked controller, such as a sever, not located at the grow location.

The embodiment of the system depicted in FIG. 5 includes five DC 24V relays (Relay 1-5) for each of the five peristaltic dosing pumps 512. These pumps may be housed in a single, separate unit, that is connectable to the controller 514 (e.g., via a single cable). This configuration allows the user to move the pump housing to wherever is most convenient in the tent to allow the placement of the various nutrients to be used. For example, the user could set the pump housing on top of the reservoir, with the different nutrient bottles in front of the reservoir, enabling space saving and easy vie ability of nutrient levels. For example, the controller 514 may have LED lights on the front of the controller 514 that would indicate each raw that is engaged as green. Meaning that if the controller 514 turns on the Chiller Relay (Relay 9), an LED above the female plug associated with the Chiller will light up as green. Unlit for off The controller 14 may also be configured with a settings page for “Active Manual Overrides” that shows anything that is manually enabled in a clear manner.

The environmental sensors 504 described below may be included in the system illustrated in FIG. 5.

The controller 514 is configured to receive data from the temperature sensor and control the exhaust fan (EXF) relays (e.g., to adjust the temperature of the system based on data received from the temperature sensor). The DC connection will enable 0-100 control over the fans. For example, 500 should be to ramp EXF 1, and if the setpoint is not reached, ramp EXF 2 until setpoint is reached. The PID loop being configured to adjust for best efficiency. The controller 514 configured to receives input from main environment temp sensor. Manual control (on/off) and server control.

The controller 514 is configured to receive data from the humidity sensor and control the de-humidifier/humidifier (DEHUM/HUM) relay. Manual control (on/off) and server control so users can use an external dehumidifier interface for operation.

The controller 514 is configured to receive data from the CO2 sensor and control the CO2 relay. Manual control (on/off) and server control.

The controller 514 is configured to calculate the Vapor pressure Deficit (VPD), which is determined based on comparison of the temperature and humidity to the leaf temperature. For example, according to one embodiment there is a menu to set the leaf temperature, which will change the VPD, 0-5 degrees Fahrenheit difference between leaf and environment temp is common. For example, VPD is the most efficient way to consider how the plant keeps itself cool and given its growth cycle, is up taking the nutrients/feeding itself. The plant feeds itself based off Transpiration, and VPD is what affects this.

The controller 514 is configured to calculate the dew point, e.g., temperature to which air must be cooled to become saturated with water vapor, correlates to the amount of water vapor in the air.

The lighting sensors described below may be included in the system illustrated in FIG. 5.

The controller 514 is configured to receive data from the PAR/PPFD sensor and control the dimming/brightening of connected LED light 520. From the server, for example, PAR ranges for each cycle of the growing phase will be defined, and the controller will be configured to ramp the PAR from the low end to the high end of the range over the course of the given growth cycle.

The system may also be configured so that users will have option to press a button and have a sensor analyze the light spectrum and display in a bar graph the different levels of the 400-700 nm spectrum.

The water sensors 506 described below may be included in the system illustrated in FIG. 5.

The system may include an NPK sensor, which enables the Monitoring of the nutrients that the plants need during the entirety of its growth cycle. Changing any of these values has the potential to affect the total performance, life/death, quality and quantity of product yield. These measurements are used by the controller to precisely dose the reservoir 2 to a specific level and test the exact responses for any plant grown. In other words, the NPK sensor enables the system to balance the exact amounts of nitrogen, phosphorous and potassium in the reservoir 2 to a finite level that has never been done before.

The system may include a pH sensor, which enables the controller 514 to adjust the pH of the reservoir 2 to a determined or predetermined level.

The system may include a PPM/EC sensor, which enables the controller 514 to balance the amount of nutrients that are fed to the reservoir 2. This number, for example, increases during the different growth stages, and the system may be configured to balance the reservoir 2 in accordance with each of the PPM values specific to its growth cycle.

The system may include a water temperature sensor, which enables the controller 514 to enable chiller relay. Maintaining specific water temperature has a significant effect on yield, and the system will seek to enable the chiller relay to maintain setpoint very finitely.

The system may include reservoir level float sensors, which enable the controller 514 to alert the user if the water in the reservoir 2 is low.

Next, one example of a startup sequence of the system is described.

The user sets up the tent in its entirety and then turns the controller on last.

The first screen to appear will be the Wi-Fi Login Page in the Settings Tab. The user will connect to local User clicks save. The controller will search for previously connected Wi-Fi if a user is already set up/has used the controller before. Upon turning on, the controller will try to connect to stored Wi-Fi if available.

Next, the user will link the controller serial number with their email address and registration information (e.g., Login and Account Setup page).

Next, the user enters the number of lights they have (fixtures) and the wattage of the light (Lighting-Fixture Settings page). The default may be set to (1) 650 Watt Light.

Next, the user designates each pump, enter in the N:P:K settings for each nutrient they are using, and save (Hydroponics-Pump Settings page). The default settings may be as follows: Pump 1: pH Down: Pump 2: pH UP; Pump 3: Rooting Hormone; Pump 4: Vegetative Cycle Nutrient; Pump 5: Flowering Cycle Nutrient.

Next, the user sets the NPK ratios for each of the nutrients and sets the NPK setting for the reservoir, which should be the VEGETATIVE state nutrient to start (Hydroponics-NPK Settings page)

Next, the user sets the temperature of the water for the controller to maintain and if they are using a chiller or not (Hydroponics->Water Temperature page).

The user sets the parameters of the humidifier or dehumidifier, if used (Settings-Humidity page).

The user will then select whether to use the system's Learning Mode (“Learning Mode” page), described above. It is recommended for users NOT to skip learning mode. After Learning Mode is completed OR users have skipped it, the user will have option to “Start A New Grow”. Users will then go through the process of starting a new grow. Upon entering all applicable information and Clicking save, the controller will initiate the grow cycle for the selected plant.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented. in computer software may be implemented in software, firmware, middleware, microcode, hardware description languages, or any combination thereof A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the methods and embodiments described herein. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied. in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc, laser disc, optical disc, digital versatile disc, floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present subject matter. Various modifications to these embodiments will be readily apparent to those skilled in the art, and the generic principles defined herein may be applied to other embodiments without departing from the spirit or scope of the subject matter. Thus, the present subject matter is not intended to be limited to the embodiments shown herein but is to be accorded the widest scope consistent with the following claims and the principles and novel features disclosed herein.

What is claimed is:

1. A hydroculture control system, comprising:
a controller;
a plurality of lights controlled by the controller;
a flood tray illuminated by the plurality of lights;
a water reservoir, wherein water is circulated between the flood tray and the reservoir via a pump;
a plurality of sensors configured to take measurements and send data to the controller, wherein plants are grown in a substrate in the flood tray, and
wherein the controller is configured to trigger one or more of the following to modify environmental conditions of the flood tray: exhaust fan, de-humidifier, air pump, and chiller.

2. The hydroculture control system according to claim 1, wherein the controller is an adaptive PID controller.

3. The hydroculture control system according to claim 2, wherein the adaptive PID controller is configured to manage growth cycles of the plants grown in the substrate based on real time inputs from the plurality of sensors.

4. The hydroculture control system according to claim 1, wherein the controller is configured to control a temperature of the flood tray by increasing illumination level of the plurality of lights.

5. The hydroculture control system according to claim 4, wherein the controller is configured to further control a temperature of the flood tray by adjusting control of a fan in the system.

6. The hydroculture control system according to claim 1, wherein the controller is configured to log sequence of the trigger actions as retrievable historical data to form operating parameters.

7. The hydroculture control system according to claim 1, wherein the system is fully automated.

8. The hydroculture control system according to claim 7, wherein a gm program is uploaded to the controller by a server so that the controller will continue to run the program in wi-fi denied environment.

9. The hydroculture control system according to claim 1, wherein the controller is configured to run a grow program, the grow program designed with optimal environmental conditions for growth of a specific plant.

10. The hydroculture control system according to claim 9, Wherein the controller is an adaptive PID controller that is responsive to immediate environmental changes and is configured to engage with a connected ancillary system to further condition the environment to maintain a desired environment.
